(19) United States
(12) Patent Application Publication
(10) Pub. No.: US 2025/0189990 A1
(43) Pub. Date: Jun. 12, 2025

(54) STREAMING ANALYTICS IN SWARM ROBOTS

(71) Applicant: International Business Machines Corporation, Armonk, NY (US)

(72) Inventors: Henry Chiu, San Jose, CA (US); Jingdong SUN, Rochester, MN (US); Bradley William Fawcett, Byron, MN (US); Jason A. Nikolai, Rochester, MN (US); Paul Gerver, Rochester, MN (US)

(21) Appl. No.: 18/536,167

(22) Filed: Dec. 11, 2023

(51) Int. Cl. G05D 1/698

(52) U.S. Cl. CPC G05D 1/698

(57) ABSTRACT

An approach is provided that manages a streaming application using a swarm of robots. It involves assigning a set of processing elements to a selected group of robots within a first swarm, with each robot performing a specific operation within the application. The process includes the active monitoring of the performance of these robots. Based on this monitoring, there is a dynamic reassignment of the processing elements. This reassignment leads to the selection of a different group of robots, potentially varying in number from the first group.

### BACKGROUND

Swarm robotics is a field of study within robotics and artificial intelligence that focuses on the design and deployment of multiple robots that operate autonomously and collaboratively to achieve specific tasks. This approach is inspired by the natural behavior of social insects like ants, bees, and termites, which exhibit complex collective behaviors arising from the interactions among large numbers of simple individuals. The central premise of swarm robotics is that a group of relatively simple, individually limited robots can collectively perform complex tasks in a robust and flexible manner. These robots typically communicate with each other through local interactions and environmental cues, which allow them to coordinate and adapt to dynamic environments. Swarm robotics has applications in various domains, including search and rescue operations, environmental monitoring, and agricultural tasks, due to its scalability, robustness against individual failures, and capability to cover large areas. The technical challenges in this field involve designing effective communication and coordination protocols, developing algorithms for decentralized decision-making, and ensuring the reliability and efficiency of the individual robots and the swarm as a whole.

### SUMMARY

An approach is provided that manages a streaming application using a swarm of robots. It involves assigning a set of processing elements to a selected group of robots within a first swarm, with each robot performing a specific operation within the application. The process includes the active monitoring of the performance of these robots. Based on this monitoring, there is a dynamic reassignment of the processing elements. This reassignment leads to the selection of a different group of robots, potentially varying in number from the first group.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram depicting swarm robots self-organizing and coordinating in order to run streaming operations efficiently;

FIG. 4 is a flowchart depicting steps taken perform streaming analytics in swarm robotics;

FIG. 5 is a flowchart depicting steps taken to initialize a selected type of robot for self-organization and coordination; and

FIG. 6 is a flowchart depicting steps taken by initialized swarms of robots to perform field operations that run streaming operations efficiently.

### DETAILED DESCRIPTION

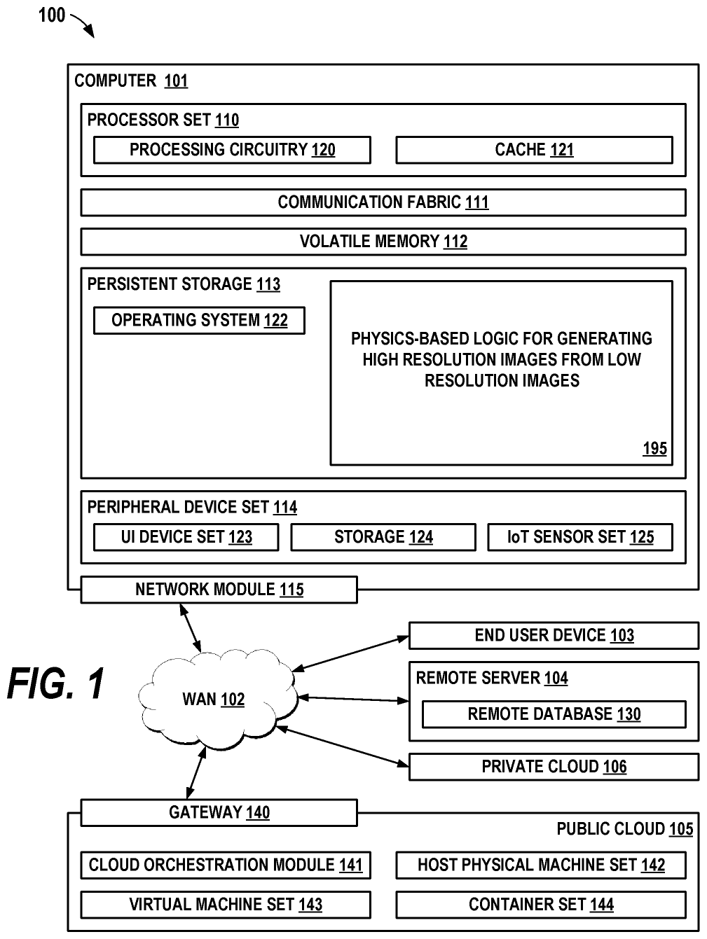

FIGS. 1-6 describe an approach that self-organizes and coordinates workflow amongst a swarm of robots in order to run streaming operations efficiently. In the realm of swarm robotics, the traditional approach has focused on programming robots to perform specific tasks. However, the approach described herein represents a significant advancement, reframing a swarm colony as a versatile platform for streaming analytics. This innovative perspective likens agents within a swarm to worker nodes in a distributed cluster environment. These nodes possess the unique advantage of mobility, enabling them to alter their physical formation to enhance job throughput. This dynamic attribute allows for the simultaneous execution of multiple streaming applications, which can be dynamically submitted or canceled within a swarm of drones.

A notable feature of this approach is the capability of swarm agents to receive dynamic updates, thereby adjusting their functionalities to suit varying requirements of distinct real-time streaming applications. This adaptability is crucial in ensuring optimal performance across a range of tasks. To achieve this, the system employs various streaming methodologies, including host colocation and ex-location groups, as well as partition colocation and ex-location groups. These groups dictate the arrangement of operators within an application, either by clustering them on a single resource or by distributing them to prevent overloading. Host colocation groups facilitate the sharing of resource-scoped resources among related operators, while partition colocation groups enhance communication efficiency between operators grouped within a processing element (PE). Conversely, ex-location groups prevent resource overloading by ensuring a balanced distribution of operators.

A critical aspect of this system is its ability to adapt to changing environmental conditions through the rescheduling of processing elements. This rescheduling aims to optimize throughput, addressing issues such as an agent becoming CPU or memory bound, which can reduce the overall efficiency of the streaming application. The system can split processing elements into smaller units and redistribute them among agents with more computing resources, or it can fuse processing elements to minimize network latency. Furthermore, agents can physically reposition themselves to achieve better performance.

In scenarios where a region within a streams application becomes bottlenecked due to a spike in incoming data, the system can respond by parallelizing the region or expanding its capacity. This involves including additional physical agents to form a logical parallel region, thus providing extra nodes to handle computationally demanding tasks concurrently. This flexibility and responsiveness of the swarm system exemplify its robustness and adaptability in diverse streaming applications.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

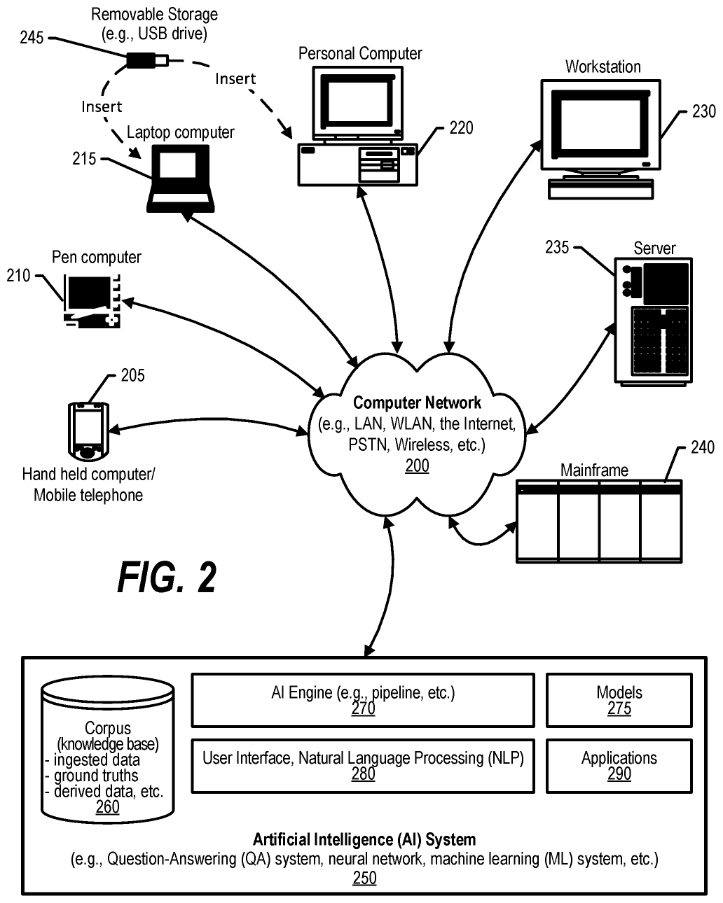

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 1 is a block diagram of a data processing system in which the methods described herein can be implemented. Computing environment 100 contains an example of an environment for the execution of at least some of the computer code involved in performing the inventive methods, such as shown in the description of block 195. In addition to block 195, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 195, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 195 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface-type operating systems that employ a kernel. The code included in block 195 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

A NETWORKED ENVIRONMENT is shown in FIG. 2. The networked environment provides an extension of the information handling system shown in FIG. 1 illustrating that the methods described herein can be performed on a wide variety of information handling systems that operate in a networked environment, depicted by computer network 200. Types of computer networks can include local area networks (LANs), wide area networks (WANs), the Internet, peer-to-peer networks, public switched telephone networks (PSTNs), wireless networks, etc. Types of information handling systems range from small handheld devices, such as handheld computer/mobile telephone 205 to large mainframe systems, such as mainframe computer 240. Examples of handheld computer 205 include smart phones, personal digital assistants (PDAs), personal entertainment devices, such as MP3 players, portable televisions, and compact disc players. Other examples of information handling systems include pen, or tablet, computer 210, laptop, or notebook, computer 215, personal computer 220, workstation 230, and server computer system 235. Other types of information handling systems that are not individually shown in FIG. 2 can also be interconnected other computer systems via computer network 200.

Many of the information handling systems include nonvolatile data stores, such as hard drives and/or nonvolatile memory depicted in FIG. 1. These nonvolatile data stores and/or memory can be included, or integrated, with a particular computer system or can be an external storage device, such as an external hard drive. In addition, removable nonvolatile storage device 245 can be shared among two or more information handling systems using various techniques, such as connecting the removable nonvolatile storage device 245 to a USB port or other connector of the information handling systems.

An ARTIFICIAL INTELLIGENCE (AI) SYSTEM is depicted at the bottom of FIG. 2. Artificial intelligence (AI) system 250 is shown connected to computer network 200 so that it is accessible by other computer systems 205 through 240. AI system 250 runs on one or more information handling systems (comprising one or more processors and one or more memories, and potentially any other computing device elements generally known in the art including buses, storage devices, communication interfaces, and the like) that connects AI system 250 to computer network 200. The network 200 may include multiple computing devices 104 in communication with each other and with other devices or components via one or more wired and/or wireless data communication links, where each communication link may comprise one or more of wires, routers, switches, transmitters, receivers, or the like. AI system 250 and network 200 may enable functionality, such as question/answer (QA) generation functionality, for one or more content users. Other embodiments of AI system 250 may be used with components, systems, sub-systems, and/or devices other than those that are depicted herein.

AI system 250 maintains corpus 260, also known as a “knowledge base,” which is a store of information or data that the AI system draws on to solve problems. This knowledge base includes underlying sets of facts, ground truths, assumptions, models, derived data, and rules which the AI system has available in order to solve problems. In one embodiment, a content creator creates content in corpus 260. This content may include any file, text, article, or source of data for use in AI system 250. Content users may access AI system 250 via a network connection or an Internet connection to the network 200, and, in one embodiment, may input questions to AI system 250 that may be answered by the content in the corpus of data. As further described below, when a process evaluates a given section of a document for semantic content, the process can use a variety of conventions to query it from the AI system.

AI system 250 may be configured to receive inputs from various sources. For example, AI system 250 may receive input from the network 200, a corpus of electronic documents or other data, a content creator, content users, and other possible sources of input. In one embodiment, some or all of the inputs to AI system 250 may be routed through the network 200. The various computing devices on the network 200 may include access points for content creators and content users. Some of the computing devices may include devices for a database storing the corpus of data. The network 200 may include local network connections and remote connections in various embodiments, such that AI system 250 may operate in environments of any size, including local and global, e.g., the Internet. Additionally, AI system 250 serves as a front-end system that can make available a variety of knowledge extracted from or represented in documents, network-accessible sources and/or structured data sources. In this manner, some processes populate the AI system with the AI system also including input interfaces to receive knowledge requests and respond accordingly.

AI Engine 270, such as a pipeline, is an interconnected and streamlined collection of operations. The information works its way into and through a machine learning system, from data collection to training models. During data collection, such as data ingestion, data is transported from multiple sources, such as sources found on the Internet, into a centralized database stored in corpus 260. The AI system can then access, analyze, and use the data stored in its corpus.

Models 275 are the result of Al modeling. Al modeling is the creation, training, and deployment of machine learning algorithms that emulate logical decision-making based on the data available in the corpus with the system sometimes utilizing additional data found outside the corpus. Al models 275 provide AI system 250 with the foundation to support advanced intelligence methodologies, such as real-time analytics, predictive analytics, and augmented analytics.

User interface 280, such as Natural Language (NL) Processing (NLP) is the interface provided between AI system 200 and human uses. Semantic content is content based on the relation between signifiers, such as words, phrases, signs, and symbols, and what they stand for, their denotation, or connotation. In other words, semantic content is content that interprets an expression, such as by using NLP. Semantic data is stored as part of corpus 260. In one embodiment, the process sends well-formed questions (e.g., natural language questions, etc.) to the AI system. AI system 250 may interpret the question and provide a response to the content user containing one or more answers to the question. In some embodiments, AI system 250 may provide a response to users in a ranked list of answers. Other types of user interfaces (UIs) can also be used with AI system 250, such as a command line interface, a menu-driven interface, a Graphical User Interface (GUI), a Touchscreen Graphical User Interface (Touchscreen GUI), and the like.

AI applications 290 are various types of AI-centric applications focused on one or more tasks, operations, or environments. Examples of different types of AI applications include search engines, recommendation systems, virtual assistants, language translators, facial recognition and image labeling systems, and question-answering (QA) systems.

In some illustrative embodiments, AI system 250 may be a question/answering (QA) system, which is augmented with the mechanisms of the illustrative embodiments described hereafter. A QA type of AI system 250 may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the I QA system. The statistical model may then be used to summarize a level of confidence that the QA system has regarding the evidence that the potential response, i.e. candidate answer, is inferred by the question. This process may be repeated for each of the candidate answers until the QA system identifies candidate answers that surface as being significantly stronger than others and thus, generates a final answer, or ranked set of answers, for the input question.

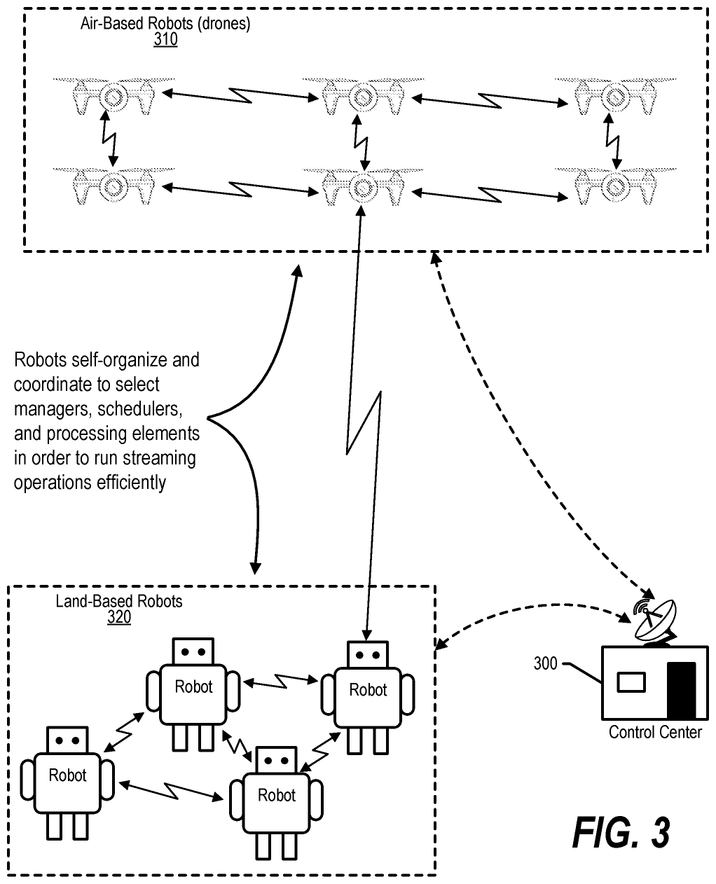

FIG. 3 is a component diagram depicting swarm robots self-organizing and coordinating in order to run streaming operations efficiently. The disclosed approach, executed by a processor linked to a memory, involves a multi-step process using swarm of robots 310 for managing a streaming application. Initially, a group of robots is chosen from swarm 310 to handle different operations of the application. These robots then process the application, with their performance being continuously monitored by another robot or by control center 300. Based on this monitoring, there is a dynamic reassignment of tasks within the swarm, resulting in a different set of robots taking over the operations, potentially differing in number from the initial group.

An extension of this approach includes instructing one or more robots from the initial group to move closer to each other to enhance the performance of the streaming application. In a scenario involving two distinct types of robotic swarms, such as air-based drones 310 and ground-based robots 320, the approach applies equally to both swarms. This includes the steps of assigning, processing, monitoring, and dynamically reassigning tasks, with the possibility of data exchange between robots of different swarms.

Furthermore, the approach includes the ability to modify the distribution of tasks among the robots. This can involve fusing two tasks into one and assigning them to a single robot, or splitting a single task into multiple parts and distributing them among additional robots from the swarm. Additionally, the approach proposes designating a specific robot from the swarm as a ‘stream schedule manager’. This robot's responsibilities include dividing the streaming application into various tasks and allocating these tasks to available robots in the swarm. This approach ensures a flexible and efficient management of the streaming application, adapting to changing conditions and requirements.

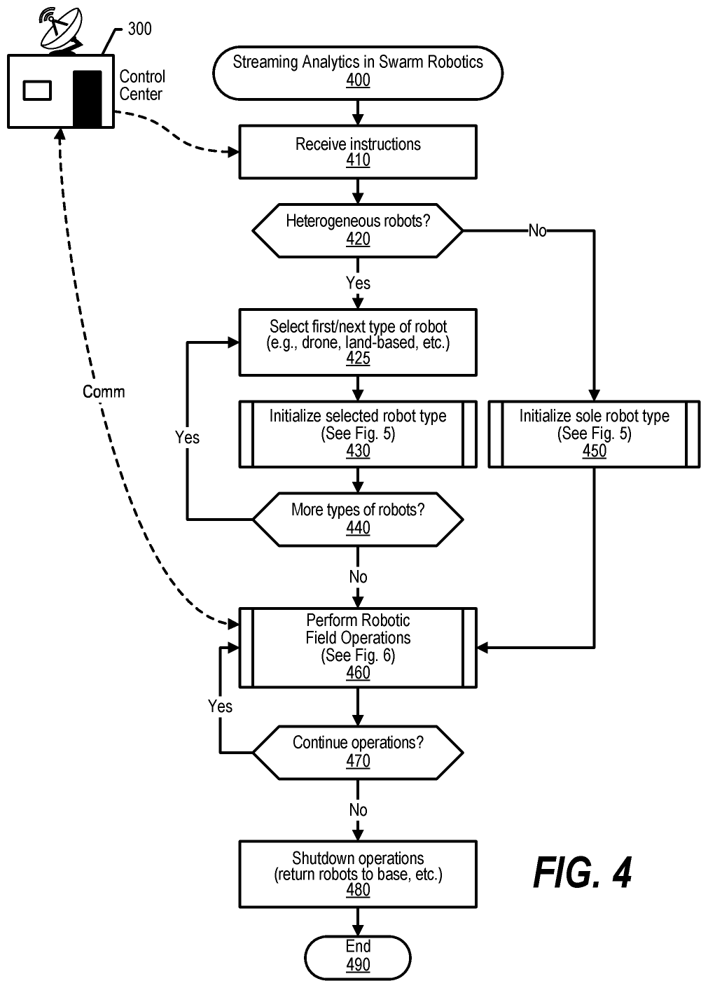

FIG. 4, as outlined in the technical description, presents a detailed flowchart for performing streaming analytics in swarm robotics, starting at step 400. The process initiates with the receipt of instructions from the control center 300 at step 410. Subsequently, the process assesses whether heterogeneous types of robots are being deployed, as indicated at decision point 420. If the deployment involves heterogeneous robots, the process follows the ‘yes’ branch, engaging in a loop involving steps 425, 430, and 440.

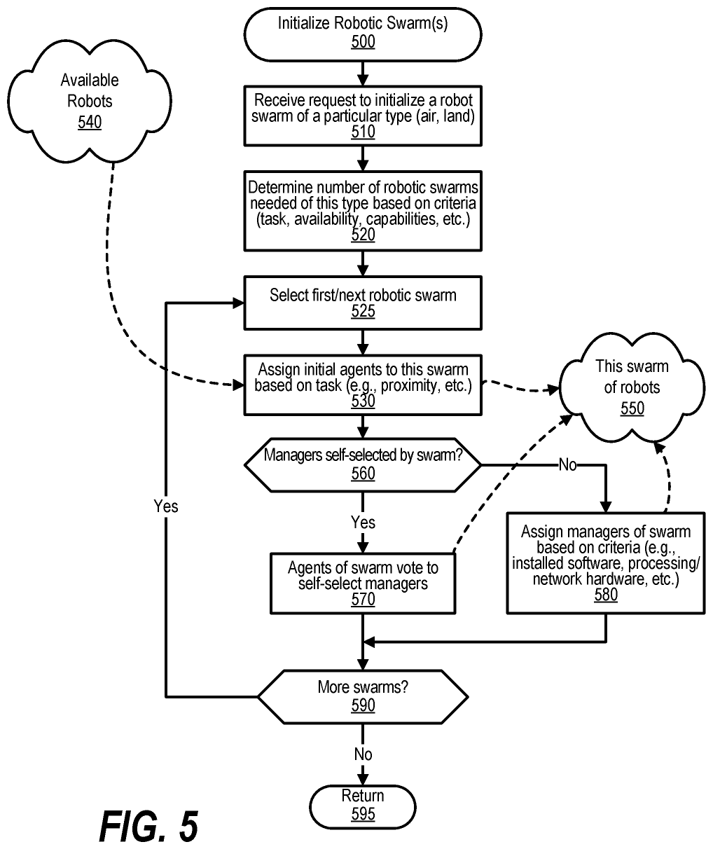

In this loop, the first action at step 425 involves selecting the initial type of robot, which could vary in nature (e.g., drone, land-based). Following this, at predefined process 430, the selected robot type undergoes an initialization routine, details of which are provided in FIG. 5 and its corresponding description. The process then evaluates whether additional types of robots need to be deployed at decision point 440. If more robot types are to be deployed, the process loops back to step 425 to select and initialize the next type of robot. This cycle continues until all robot types have been initialized, after which the process exits the loop following the ‘no’ branch at decision point 440.

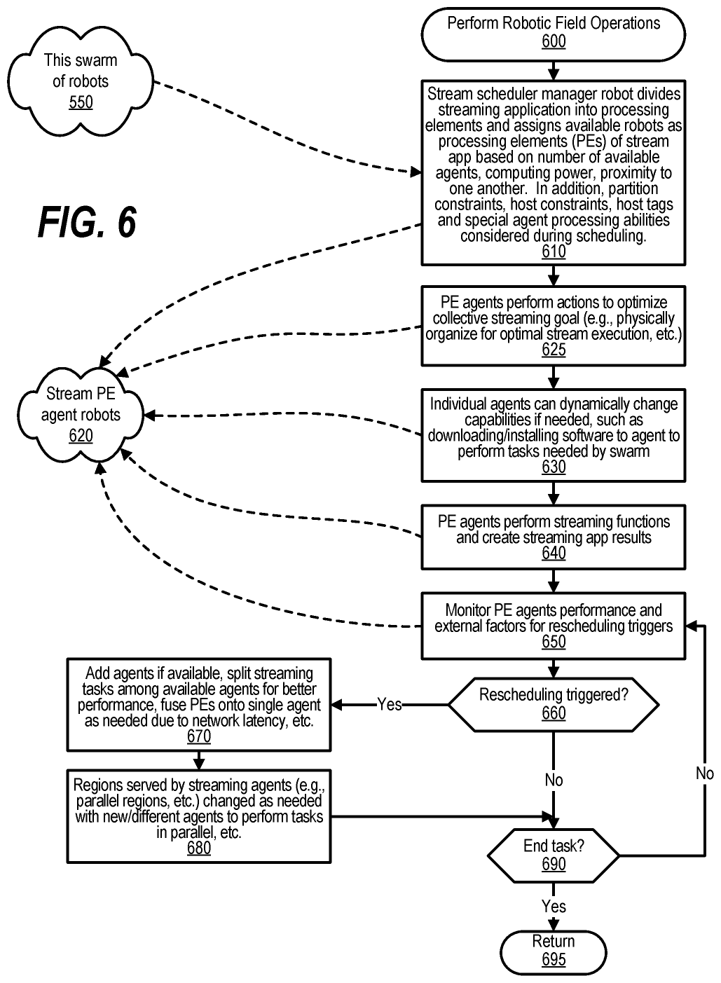

Once the initialization of all robot types is complete, the process moves to predefined process 460, where the Robotic Field Operations routine is performed, with further details available in FIG. 6 and its accompanying text. The process then determines the continuity of operations at decision point 470. If operations are ongoing, the process returns to predefined process 460 to continue field operations, looping back as necessary. Once the operations conclude, the process exits this loop following the ‘no’ branch at decision 470.

Finally, at step 480, the process concludes by shutting down operations, which includes returning the robots to their base. The entire process detailed in FIG. 4 reaches completion at step 490.

In contrast, if heterogeneous robots are not deployed, as determined at decision point 420, the process follows the ‘no’ branch to predefined process 450. Here, the process undertakes the Initialize sole robot type routine, the details of which are again referred to in FIG. 5 and its associated text. This pathway represents a streamlined process in cases where only a single type of robot is deployed in the streaming analytics operation.

FIG. 5 presents a flowchart illustrating the steps for initializing a selected type of robot for self-organization and coordination within robotic swarms. The process begins at step 500, where it specifically addresses the initialization of robotic swarms.

The first step, at 510, involves receiving a request to initialize a robot swarm, which can be of various types such as air or land-based. Following this, at step 520, the process determines the number of robotic swarms required of this specific type. This determination is based on a set of criteria including the task at hand, availability of robots, and their capabilities.

Once the need for the number of swarms is established, the process proceeds to step 525, where it selects the first robotic swarm. At step 530, initial agents are assigned to this swarm, with the selection being task-oriented. Factors like proximity may influence this decision. These agents are chosen from the pool of available robots, indicated at reference 540, and the robots assigned to this particular swarm are represented by swarm 550.

A critical decision point is reached at step 560, where the process evaluates whether managers for the swarm have been self-selected. If the swarm has self-selected its managers, the process follows the ‘yes’ branch to step 570. Here, the agents within the swarm participate in a voting process to self-select their managers. Conversely, if the swarm has not self-selected its managers, the process follows the ‘no’ branch to step 580. In this scenario, the managers of the swarm are assigned based on specific criteria, such as installed software or processing/network hardware capabilities.

The process then assesses at decision point 590 whether there are additional swarms to process. If more swarms require processing, the process loops back to step 525 to select and initialize the next swarm. This looping continues until all identified swarms have been processed. Upon completion of processing all the swarms, the process exits the loop following the ‘no’ branch at decision 590.

Finally, the processing outlined in FIG. 5 concludes at step 595, where it returns to the calling routine, as detailed in FIG. 4. This flowchart effectively details the comprehensive steps involved in initializing various types of robotic swarms, focusing on self-organization and coordination to optimize their functionality for specific tasks and environments.

FIG. 6 is a flowchart that outlines the steps taken by initialized swarms of robots to perform field operations for efficient streaming operations. The process begins at step 600 and is specifically tailored to handle Robotic Field Operations.

At the outset, step 610 involves the streams scheduler manager robot dividing a streaming application into processing elements. This robot then assigns available robots from the swarm, indicated as swarm 550, as processing elements (PEs) of the stream application. The assignment is based on factors such as the number of available agents, their computing power, and proximity to each other. Additionally, partition constraints, host constraints, host tags, and special agent processing abilities are considered during this scheduling. The processing element robots are depicted at reference 620.

Following this, at step 625, the process involves the PE agents taking actions to optimize the collective streaming goal. This might include physically organizing themselves for optimal stream execution. Step 630 then allows individual agents within the process to dynamically change their capabilities as needed. This might involve downloading and installing new software to enable an agent to perform tasks required by the swarm.

Step 640 sees the PE agents performing streaming functions and creating results for the streaming application. Subsequently, at step 650, the process involves monitoring the performance of the PE agents as well as external factors to identify triggers for rescheduling.

A critical decision point is reached at decision 660, where the process determines if rescheduling is necessary. If rescheduling is triggered, the process follows the ‘yes’ branch to steps 670 and 680. If not, it bypasses these steps along the ‘no’ branch. Step 670 involves adding agents if available, splitting streaming tasks among available agents for enhanced performance, and fusing PEs onto a single agent as needed due to factors like network latency. At step 680, the regions served by streaming agents, such as parallel regions, are changed as necessary, integrating new or different agents to perform tasks in parallel.

Finally, at decision 690, the process evaluates whether the task has concluded, such as the completion of an aerial reconnaissance of an area. If the task is finished, the process follows the ‘yes’ branch and returns to the calling routine (as indicated in FIG. 4) at step 695. However, if the task has not yet concluded, the process loops back to step 650 via the ‘no’ branch, continuing the operations. This flowchart provides a comprehensive guide for the operational management of robotic swarms in field operations, emphasizing efficiency and adaptability in streaming operations.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method, implemented by a processor coupled to a memory, comprising:
assigning a set of processing elements to perform a streaming application by a selected first plurality of robots included in a first swarm of robots, wherein each of the first plurality of robots perform an operation of the steaming application;
processing the streaming application by the first plurality of robots;
monitoring a performance of the first plurality of robots; and
dynamically reassigning the set of processing elements based on the monitoring, the reassigning resulting in a selected second plurality of robots, wherein a first total number of the first plurality is different than a second total number of the second plurality.

2. The method of claim 1 further comprising:
instructing at least one of the first plurality of robots to move to a location proximate to another of the first plurality of robots to optimize the streaming application.

3. The method of claim 1, wherein the first swarm of robots is of a first robotic type, and a second swarm of robots is of a second robotic type, wherein the method further comprises:
performing the assigning, processing, monitoring, and dynamic reassigning steps with the second swarm of robots.

4. The method of claim 3 further comprising:
communicating a set of data between one of the robots included in the first swarm of robots and one of the robots included in the second swarm of robots, wherein the first robotic type is an air-based drone type of robot and wherein the second robotic type is a ground-based type of robot.

5. The method of claim 1 wherein the dynamically reassigning further comprises:
fusing two processing elements into a single agent, wherein the fused two processing elements are assigned to a selected one of the first plurality of robots.

6. The method of claim 1 wherein the dynamically reassigning further comprises:
splitting one of the processing elements into a plurality of processing elements; and
adding at least one of the robots in the swarm of robots to the first plurality of robots, wherein each of the plurality of processing elements is assigned to a different robot from the swarm of robots.

7. The method of claim 1 further comprising:
assigning a selected one of the first swarm of robots as a stream schedule manager robot, wherein the stream schedule manager robot performs actions comprising:
dividing the streaming application into the processing elements; and
assigning available robots from the first swarm of robots to the processing elements.

8. An information handling system comprising:
one or more processors;
a memory coupled to at least one of the processors; and
a set of instructions stored in the memory and executed by at least one of the processors to perform actions comprising:
assigning a set of processing elements to perform a streaming application by a selected first plurality of robots included in a first swarm of robots, wherein each of the first plurality of robots perform an operation of the steaming application;
processing the streaming application by the first plurality of robots;
monitoring a performance of the first plurality of robots; and
dynamically reassigning the set of processing elements based on the monitoring, the reassigning resulting in a selected second plurality of robots, wherein a first total number of the first plurality is different than a second total number of the second plurality.

9. The information handling system of claim 8 wherein the actions further comprise:
instructing at least one of the first plurality of robots to move to a location proximate to another of the first plurality of robots to optimize the streaming application.

10. The information handling system of claim 8, wherein the first swarm of robots is of a first robotic type, and a second swarm of robots is of a second robotic type, wherein the actions further comprise:
performing the assigning, processing, monitoring, and dynamic reassigning steps with the second swarm of robots.

11. The information handling system of claim 10 wherein the actions further comprise:
communicating a set of data between one of the robots included in the first swarm of robots and one of the robots included in the second swarm of robots, wherein the first robotic type is an air-based drone type of robot and wherein the second robotic type is a ground-based type of robot.

12. The information handling system of claim 8 wherein the dynamically reassigning further comprises:
fusing two processing elements into a single agent, wherein the fused two processing elements are assigned to a selected one of the first plurality of robots.

13. The information handling system of claim 8 wherein the dynamically reassigning further comprises:
splitting one of the processing elements into a plurality of processing elements; and
adding at least one of the robots in the swarm of robots to the first plurality of robots, wherein each of the plurality of processing elements is assigned to a different robot from the swarm of robots.

14. The information handling system of claim 8 wherein the actions further comprise:
assigning a selected one of the first swarm of robots as a stream schedule manager robot, wherein the stream schedule manager robot performs actions comprising:
dividing the streaming application into the processing elements; and assigning available robots from the first swarm of robots to the processing elements.

15. A computer program product comprising:
a computer readable storage medium comprising a set of computer instructions that, when executed by a processor, are effective to perform actions comprising:
assigning a set of processing elements to perform a streaming application by a selected first plurality of robots included in a first swarm of robots, wherein each of the first plurality of robots perform an operation of the steaming application;
processing the streaming application by the first plurality of robots;
monitoring a performance of the first plurality of robots; and
dynamically reassigning the set of processing elements based on the monitoring, the reassigning resulting in a selected second plurality of robots, wherein a first total number of the first plurality is different than a second total number of the second plurality.

16. The computer program product of claim 15 wherein the actions further comprise:
instructing at least one of the first plurality of robots to move to a location proximate to another of the first plurality of robots to optimize the streaming application.

17. The computer program product of claim 15, wherein the first swarm of robots is of a first robotic type, and a second swarm of robots is of a second robotic type, wherein the actions further comprise:
performing the assigning, processing, monitoring, and dynamic reassigning steps with the second swarm of robots.

18. The computer program product of claim 17 wherein the actions further comprise:
communicating a set of data between one of the robots included in the first swarm of robots and one of the robots included in the second swarm of robots, wherein the first robotic type is an air-based drone type of robot and wherein the second robotic type is a ground-based type of robot.

19. The computer program product of claim 15 wherein the dynamically reassigning further comprises:
fusing two processing elements into a single agent, wherein the fused two processing elements are assigned to a selected one of the first plurality of robots.

20.

21. The computer program product of claim 15 wherein the dynamically reassigning further comprises:
splitting one of the processing elements into a plurality of processing elements; and
adding at least one of the robots in the swarm of robots to the first plurality of robots, wherein each of the plurality of processing elements is assigned to a different robot from the swarm of robots.
